(19) United States
(12) Patent Application Publication
(10) Pub. No.: US 2010/0097632 A1
(43) Pub. Date: Apr. 22, 2010

(54) VERTICAL PRINT

(76) Inventor: Tomoki HATTORI, Tucker, GA (US)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/255,470

(22) Filed: Oct. 21, 2008

(51) Int. Cl. G06F 3/12; H04L 9/32

(52) U.S. Cl. 358/1.15; 726/5

(57) ABSTRACT

A method, a system, and a computer program product for controlling printing across a plurality of network devices. The method, system, and computer program product perform functions which generate a locked print job to be distributed to the plurality of network devices, which assign a user identification for identification of the locked print job at the network devices, and which assign a user password for print job authorization of the locked print job at the network devices. The method, system, and computer program product function to broadcast with a multiple network device identification print job information of the locked print job to the plurality of network devices. The system includes an originating network device of the plurality of network devices, which generates the locked print job to be distributed to the plurality of network devices. The originating network device is configured to assign the user identification and the user password for identification and print job authorization of the locked print job at the remote network devices. The originating network device is configured to broadcast with a multiple network device identification the print job information to the plurality of network devices.

### BACKGROUND OF THE INVENTION

1. Field of the Invention

The invention relates to print job controls, systems, and computer program products for controlling the printing of print jobs across networks.

2. Discussion of the Background

Some printing devices are configured with a feature known as “locked printing” to provide control over the printing of electronic documents. When a printing device is configured with a locked printing feature and print data is sent to the printing device, a printed version of an electronic document reflected in the print data is not generated until a password is verified at the printing device. Typically a user enters a password through an operation panel on the printing device. The printing device verifies the password and if the password is successfully verified, allows a printed version of the electronic document reflected in the print data to be generated, i.e., printed.

U.S. Pat. No. 7,249,900 (the entire contents of which are incorporated herein by reference) describes an approach for implementing locked printing on a printing device. The printing device includes a user interface which displays information and accepts user input. The printing device includes a locked print process which examines print data received by the printing device and determines whether locked printing is to be used for the print data. The locked print process verifies password data entered via the user interface. If the password data is successfully verified, then locked print process allows the print data to be processed to produce a printed version of the electronic document reflected in the print data.

Some locked job printing methods further include the capability to encrypt the print job. For example, when the locked job is sent to a device, it can be stored on the device in a 64-bit encryption format. While authentication ensures that users cannot get access to any details of a document, such as the document's name or the number of pages, encryption ensures that if the hard drive was removed from the device and accessed by an unauthorized user, the information stored on it would remain secure.

Typically, locked job printing methods require a user or an administrator to specify which printers on the network are to receive the locked print job or the encrypted locked print job. With these measures, the locked print jobs are not sent improperly to a wrong printer and are not inadvertently printed. Such measures help to ensure security of the locked print job, but require that the communication protocol specify the IP address of the printer for which the locked print job is to be printed, and require that the user know ahead of time where the locked print job is to printed. These measures then restrict the user from printing the locked print job at other printers, unless the user has sent the locked print job individually to all available printers through separately issued print jobs or unless the user returns to the print job source terminal and reissues the job to another printer.

### SUMMARY OF THE INVENTION

In one embodiment of the present invention, there is provided a method for controlling printing across a plurality of network devices. The method generates a locked print job to be distributed to the plurality of network devices, assigns a user identification for identification of the locked print job at the network devices, and assigns a user password for print job authorization of the locked print job at the network devices. The method broadcasts with a multiple network device identification print job information regarding the locked print job to the network devices.

In one embodiment of the present invention, there is provided a system for controlling printing across a plurality of network devices. The system includes a network connecting the plurality of network devices. The system includes an originating network device of the plurality of network devices, which generates a locked print job to be distributed to the plurality of network devices. The originating network device is configured to assign a user identification for identification of the locked print job at the network devices and to assign a user password for print job authorization of the locked print job at the network device. The originating network device is configured to broadcast with a multiple network device identification print job information regarding the locked print job to the network devices.

In one embodiment of the present invention, there is provided a computer program element for controlling printing across a plurality of network devices. The computer program product includes code elements which generate a locked print job to be distributed to the plurality of network devices, which assign a user identification for identification of the locked print job at the network devices, and which assign a user password for print job authorization of the locked print job at the network device. The computer program product includes a code element which broadcasts with a multiple network device identification print job information regarding the locked print job to the plurality of the network devices.

It is to be understood that both the foregoing general description of the invention and the following detailed description are exemplary, but are not restrictive of the invention.

### BRIEF DESCRIPTION OF THE DRAWINGS

A more complete appreciation of the present invention and many attendant advantages thereof will be readily obtained as the same becomes better understood by reference to the following detailed description when considered in connection with the accompanying drawings, wherein:

FIG. 1 is a flowchart detailing one method of the invention for issuing and controlling locked print jobs;

FIG. 2 is a network schematic showing an originating network device in communication with remote network devices;

FIGS. 3A(1)-3B(2) are exemplary window screens which can be utilized by a user issuing a locked print job;

FIGS. 4A-4C show exemplary IP and UDP datagram structures which can be used in the invention;

FIGS. 5A-5B show exemplary IP headers and UDP datagrams which can be used in the invention;

FIG. 6 is a depiction of exemplary printer control language codes for one embodiment of the invention;

FIG. 7A is another network schematic showing a network device in communication with remote network devices over different sub-networks;

FIG. 7B is an exemplary window screen which can be utilized by a user to show the queue of locked print jobs;

FIG. 8 is a flowchart detailing another method of the invention for issuing and controlling locked print jobs;

FIG. 9 is another network schematic showing a network device in communication with remote network devices over different sub-networks by way of multi-function printing devices;

FIG. 10 is a flowchart detailing another method of the invention for issuing and controlling locked print jobs;

FIG. 11 is another network schematic showing a network device in communication with a specific destination device and remote network devices;

FIG. 12A is a schematic detailing a system, without a network print server, for issuing and controlling locked print jobs;

FIG. 12B is a schematic detailing locked print job workflow in a system without a network print server;

FIG. 13A is a schematic detailing a system for issuing and controlling locked print jobs by way of a print server;

FIG. 13B is a schematic detailing a system locked print job network server; and

FIG. 13C is a schematic detailing locked print job workflow in a system with a network print server.

### DETAILED DESCRIPTION OF THE EMBODIMENTS

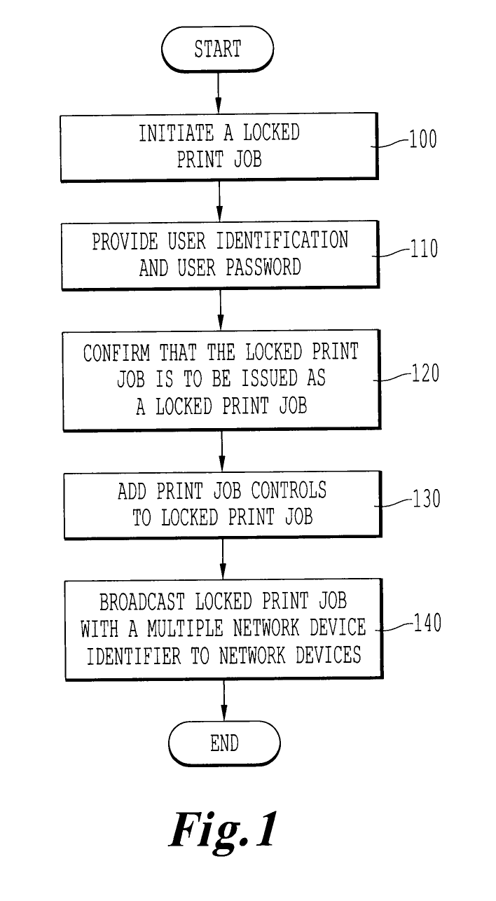

Referring now to the drawings, wherein like reference numerals designate identical, or corresponding parts throughout the several views, FIG. 1 is a flowchart detailing one method of the invention for issuing and controlling locked print jobs.

At 100 in FIG. 1, a locked print job is initiated by a user. The user may be a user of an individual terminal or an administrator controlling traffic on the network. In this embodiment, a locked print job is broadcast with a multiple network device identification to the available printers on a network or sub-network. At 110, a user identification and a user password are provided for the to-be-issued locked print job. At 120, the user confirms (or designates) that the job to-be-printed is to be a locked print job. At 130, print job language is added to the locked print job. At 140, the locked print job is broadcast with the multiple network device identification to network devices.

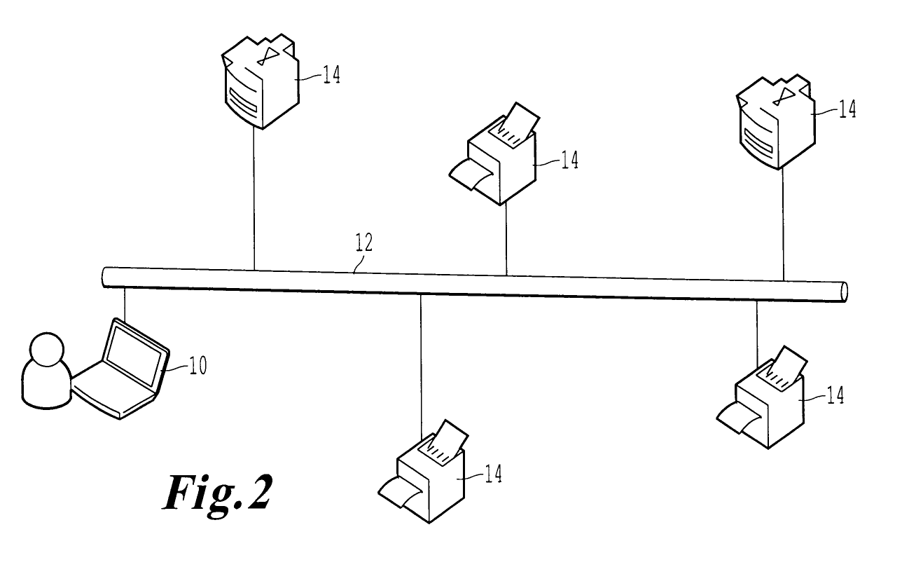

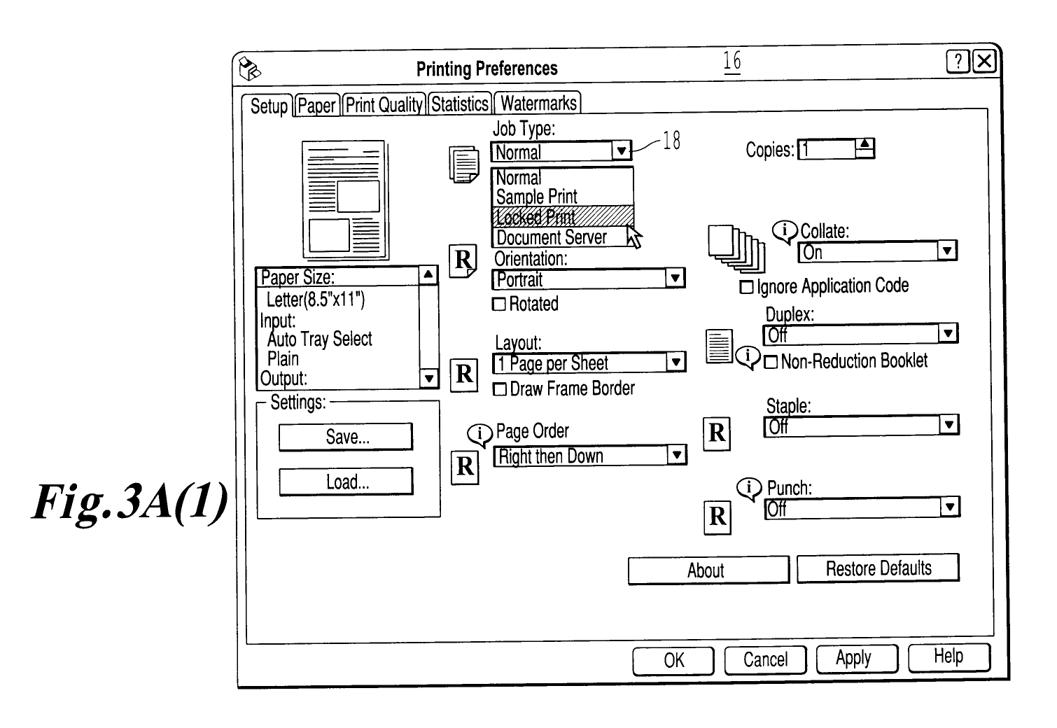

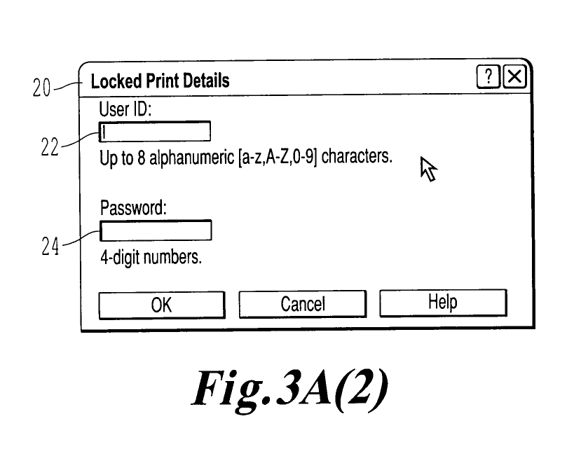

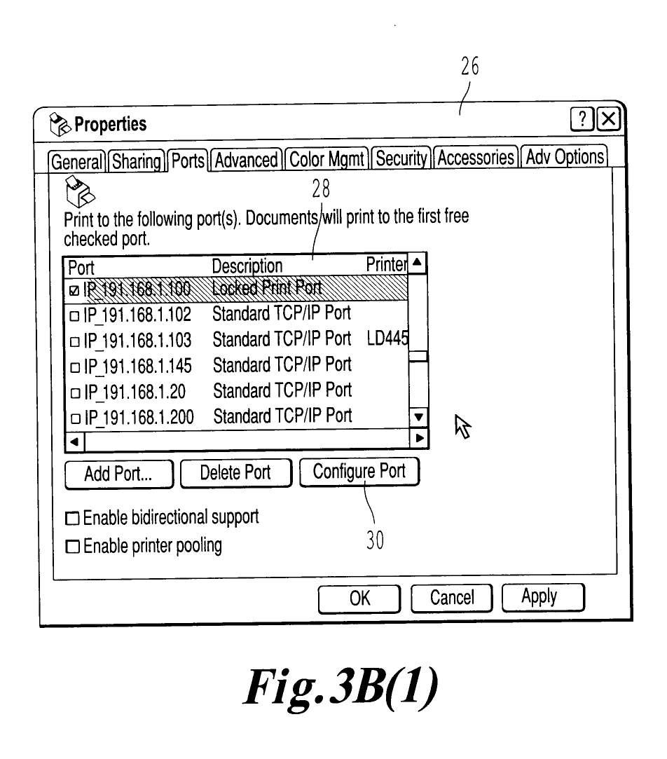

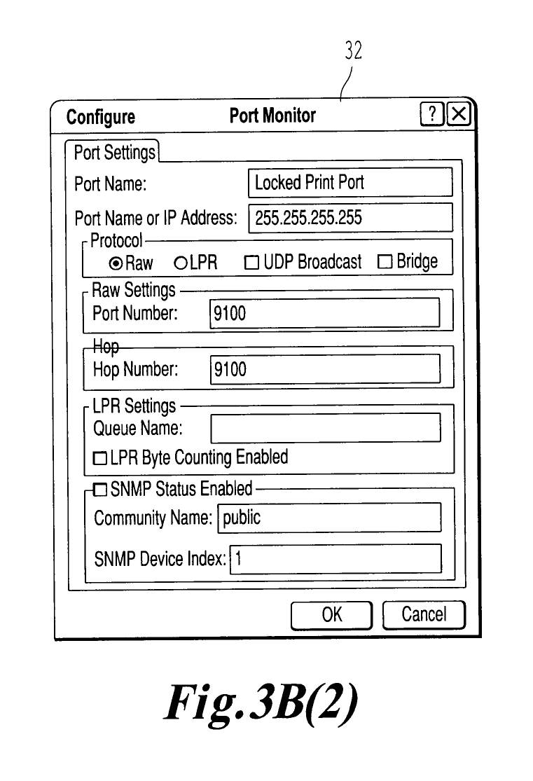

FIG. 2 is a network schematic showing an originating network device 10 in communication via a network 12 with remote network devices 14. A user of an originating network device 10 can initiate a locked print job from a print job application such a MS Word™ or Adobe Acrobat.™ The network device 10 is connected to a number of remote network devices 14 (such as for example printers or multifunction printing devices) which will all receive broadcast of the locked print job from the originating device 10. For example, FIG. 3A(1) depicts an exemplary applications window 16 in which a Job Type drop down list 18 permits a user to select whether or not a job to be printed is to be locked. If the job to be printed is to be locked, the user selects “Locked Print” inside the Job Type drop down list 18. Other options permit a user of the system to send non-locked print job by selection of for example “Normal.” FIG. 3A(1) shows that the invention also provides for standard print control features known to those skilled in the art, such as for example paper size selection, layout selection, a number of copies selection, staple selection, etc.

At 110 in FIG. 1, a user identification and a user password are provided for the to be broadcast locked print job. FIG. 3A(2) shows an example of a Locked Print Details window 20 in which 1) user ID input recorder 22 and 2) password input recorder 24 permit entry of a user identification and a user password to be associated with the locked print job. As described in more detail below, the identification and password will be used 1) to track and locate the locked print job once broadcast to the network devices 14 and 2) to provide authorization at the network devices 14 for the printing of the locked print job.

At 120 in FIG. 1, the user confirms whether or not a job to be printed is to be locked. As discussed above, by user selection of “Locked Print” inside the Job Type drop down list 16 of FIG. 3A(1), as opposed to the selection of “Normal,” the user confirms or designates the status of the job to be printed as a locked print job. After confirmation, a printer properties window 26 is generated by which a user can determine the port status of a particular printer selected. For example, FIG. 3B(1) depicts a printer properties window 26 by which a user (or network administrator) can determine the port status of a particular printer. FIG. 3B(1) depicts (in port status display 28) those specific ports available on a selected printer. The port status display 28 shows the user or network administrator details as to which ports are standard and which ports are for receiving locked print jobs. A printer (or other remote network device) can have multiple locked printer ports.

If the user or network administrator activates the “CONFIGURE PORT” button 30, then the user will be shown a Port Monitor Screen 32 as shown in FIG. 3B(2). The Port Monitor Screen 32 can include a number of controls for changing port settings, including port name, printer name or IP address, protocol, port number, and hop number. The hop number for example specifies how many subnets beyond the selected printer's network that the locked print job can be forwarded. In this way, the user or network administrator can set up network 12 with remote devices 14 having ports available for receiving a present or subsequent locked print job.

At 130 in FIG. 1, the originating network device 10 receives the print job from an application and adds print job command language to the print job such that remote devices 14 receiving the locked print job will have print job instructions for unlocking and printing the locked print job. In one embodiment of the invention, broadcast of the locked print jobs or broadcast of locked print job information occurs by way of User or Universal Datagram Protocol (UDP). UDP is a communications protocol by which datagrams are exchanged between devices on a network that use Internet Protocol (IP) datagrams or data packets for communication from device-to-device by communication to specific ports on the devices. For example, UDP communication typically provides port numbers to help distinguish different user requests. (Examples of specific datagrams for the invention will be described in more detail later.) UDP conventionally does not guarantee the reliability or the ordering for receipt of datagrams. Conventionally, UDP provides no guarantees to the upper layer protocol for message delivery, and a UDP sender retains no state information on UDP messages once sent. UDP provides an interface between an Internet Layer below (e.g., IPv4) and an Application Layer above. A UDP header typically includes four (4) fields. Source port is a field that identifies the sending port. Destination port is a field that identifies the destination port. Length is a 16-bit field that specifies the field length in bytes of the entire datagram (i.e., header and data). Checksum is a 16-bit checksum field used for error-checking of the header and data.

In one embodiment of the invention, the job instructions for printing the locked print job include print-job-handling information such as for example user information, job release synchronization information, and a job expiration date. The user information can include the user identification and password as well as information regarding the IP address of the network device 10. The job release synchronization information can include conditions for holding or deleting the locked print job from other remote devices 14 upon the printing of the locked print job. The expiration date information can include a time when the locked print job will be deleted from the remote devices 14 if it has not been printed.

At 140 in FIG. 1, the originating network device 10 broadcasts the locked print job to all remote devices 14 on the network 12. As explained below, in one aspect of the invention, the multicast format permits the simultaneous broadcast of the locked print job to all remote devices 14 without a user having to know or individually specify the IP addresses of all the remote devices 14. In another aspect of the invention, a user or an administrator knowing the IP addresses of all the remote devices 14 can set up the port configurations of all or nearly all the remote devices 14 (as explained above) and after set up broadcast all subsequent locked print jobs to all or nearly all the remote devices 14. With the network ports configured, the user need not decide ahead of time which remote device to send the locked print job to. This saves the user time and permits the user flexibility in being able to print the locked print job from any of the remote devices 14 as needed without having to resend a locked print job should the original printing resource not be available when the user needs to print the job.

In one embodiment of the invention, the user can then access the locked print job at any of the remote devices 14 and authorize display or printing of the locked print job. For example, at one of the remote devices 14, the user can access a user interface screen which includes options for accessing and printing the locked print job. Since the network devices 14 receive a broadcast of all locked print jobs originating from network device 10 (or as described in more detail below can receive a broadcast of print job information of all locked print jobs originating from network device 10), the network devices 14 each have a log entry of the broadcast locked print jobs. The user is then able to select or enter 1) a user ID and 2) the corresponding password data to be authenticated against the print job information sent to the remote device 14. For large numbers of users, an interface screen may be provided for selecting from many user IDs based upon starting numbers or letters. The user ID/password combinations may be authenticated based upon data stored locally on remote device 14. Alternatively, user ID/password combinations may be authenticated based upon data stored elsewhere. For example, remote device 14 may transmit user ID/password combinations over network 12 to an authentication server (not shown) which can authenticate the user ID/password combinations and return data to remote device 14 indicating whether the authentication was successful.

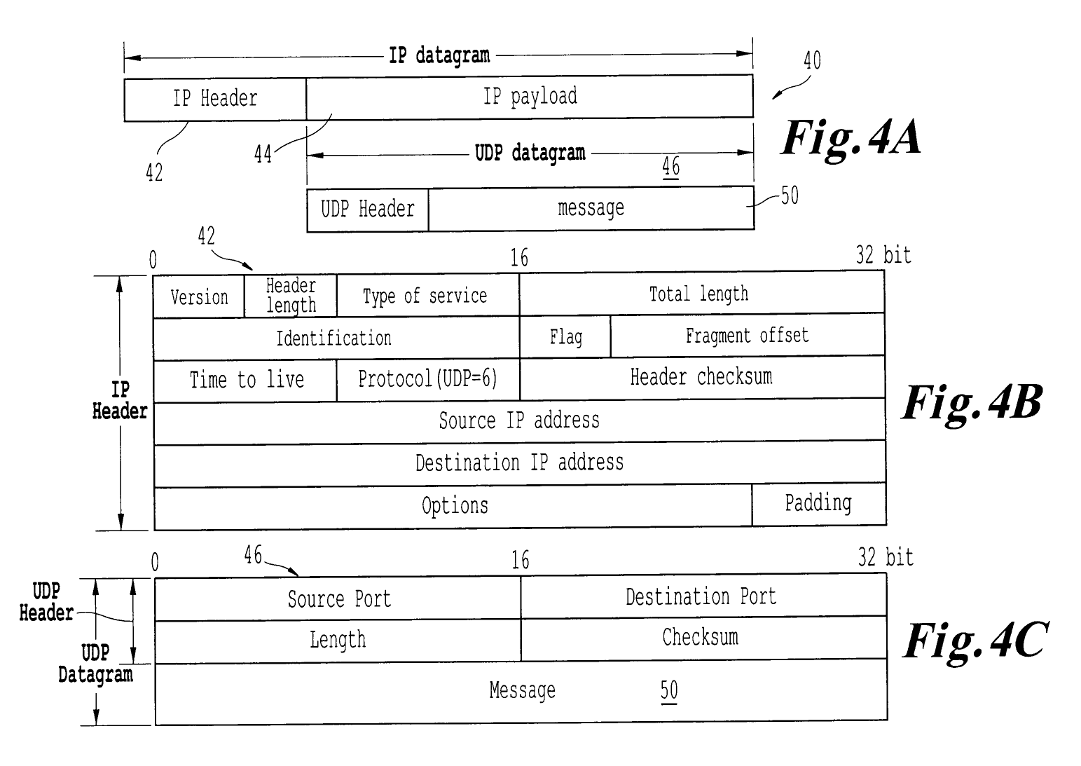

FIGS. 4A-4C show exemplary IP and UDP datagram structures which can be used in the invention to communicate the locked print job or locked print job information. FIG. 4A is a schematic representation of one embodiment of the invention in which a UDP datagram is embedded into an IP datagram or data packet. In this example, the IP datagram 40 includes an IP header 42 and an IP payload section 44. A UDP datagram 46 is included in the IP payload section 44. The UDP datagram 46 includes a UDP header and UDP message section 50. FIG. 4B is an expanded schematic of the IP header 42. The IP header as illustrated can include a version field, a header length field, a type of service field, a total length field, an identification field, a protocol field, a checksum field, a source address field, a destination address field, an options field, and a padding field 4. FIG. 4C is an expanded schematic of the UDP datagram 46. The UDP datagram 46 as illustrated can include a source port field, a destination port field, a length field, a checksum field, and a message field. The message field (as discussed in more detail below) will include print job language commands.

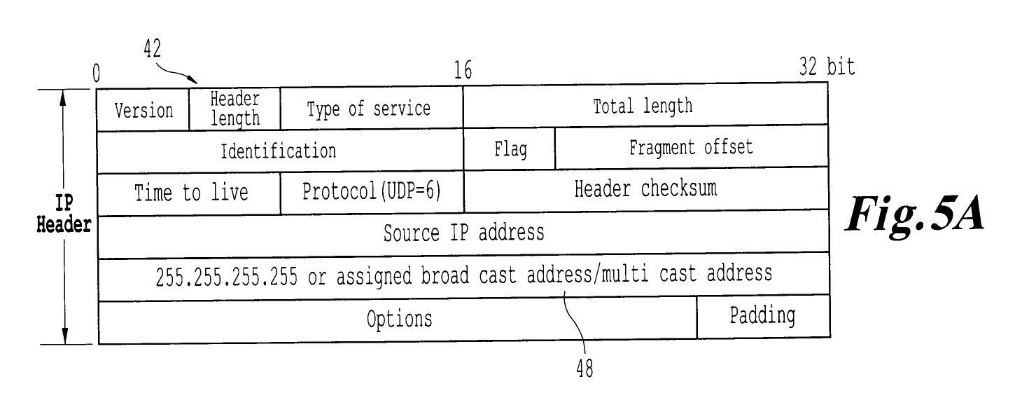

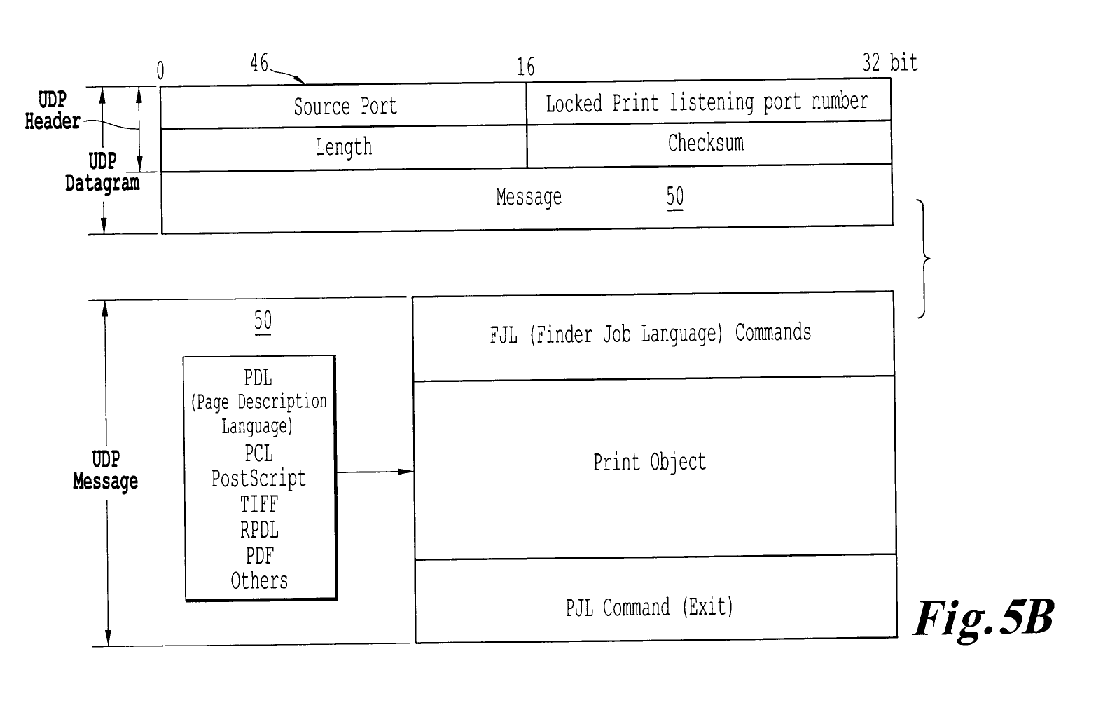

FIG. 5A is an exemplary view of an IP header 42 according to one embodiment of the invention in which the destination address field 48 includes “255.255.255.255” which permits the simultaneous or near simultaneous broadcast to all IP addresses on the network 102 of the print job data or print job information. This multiple network device identification provides a way for the user to broadcast the locked print job without user identification ahead of time of a specific network device for the printing of the locked print job. Inclusion of “255.255.255.255” in destination address field 48 typically confines distribution of the IP data packet 40 to all devices on the local network. FIG. 5A also shows in the destination address field 48 the alternative of including an assigned broadcast address or multi cast address, which might be specific to a particular network on which the remote devices 104 reside. This multiple network device identification also provides a way for the user to broadcast the locked print job without user identification ahead of time of a specific network device for the printing of the locked print job. In another example, the destination IP address field 48 can be 192.168.1.255 (i.e., a broadcast address) if the network address is 192.168.1.0 and the host address is last 8 bits (i.e., Class D subnet)

FIG. 5B is an exemplary view of an UDP datagram header 46 in which UDP message section 50 has been expanded to show the inclusion of printer job language (PJL) commands, print object, and PJL command exit. In general, PJL commands provide job level control as an extended control for print command and job control languages. One feature of PJL is its ability to switch printer languages between jobs. Applications supporting PJL can print one job using PCL and then print the next job using PostScript (or any other support printer language), without any operator intervention. PJL can also command bi-directional communications with the printer, and subsequent decisions from the result of the communication. PJL can request information from the printer such as printer model, configuration, printer status, and job status. PJL also can be used to change the printer's control panel settings (change default settings without actually using the control panel) and modify the message displayed on the control panel.

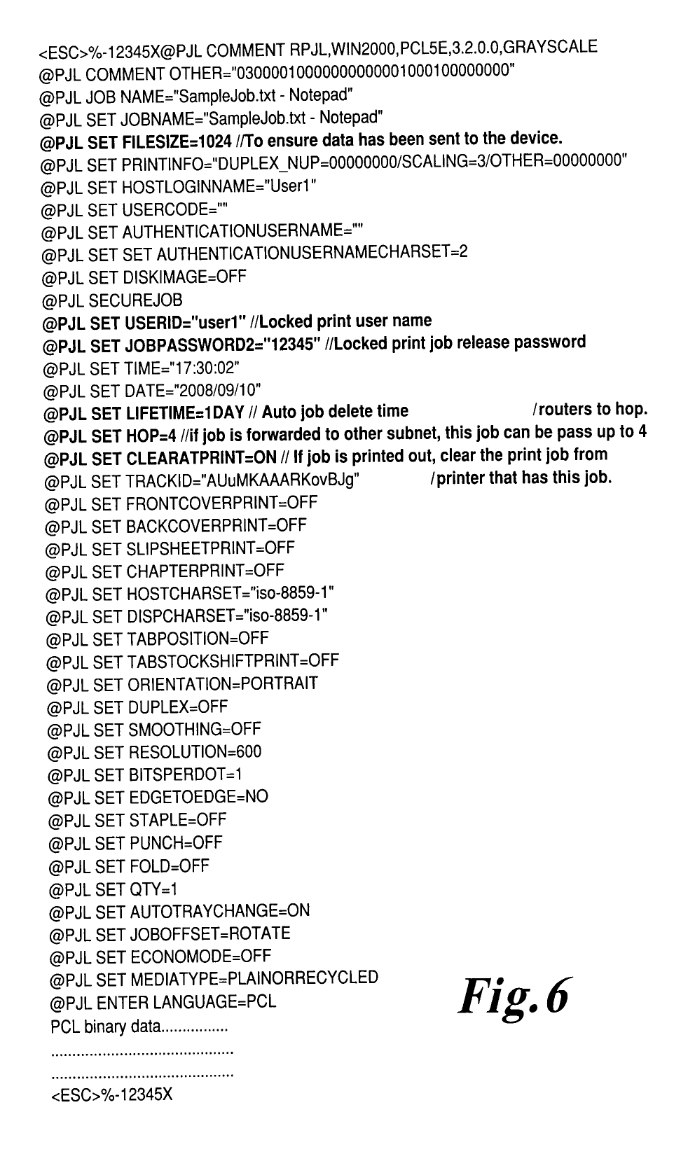

FIG. 6 is an example of a UDP Message including PCL language commands which are suitable for the invention. Many of the shown PCL commands are standard commands used over a printer network. Some of the shown PCL commands are commands developed for the invention's control of locked print job distribution and printing. For example, the code line reading “@PJL SET FILESIZE=1024//” is a command to ensure that all data has been sent to the remote network device 104. As noted above, convention UDP datagram processing has no capability for guaranteeing reliability or receipt of the broadcast datagrams. However, in the invention, this program code provides one measure of reliability by which receipt of all the broadcast datagrams can be checked.

The code line “@PJL SET USERID=‘user1’//” is a PCL command line incorporating the locked printer user name, for example as specified in FIG. 3A(2). The code line “@PJL SET JOBPASSWORD=‘12345’//” is a PCL command line incorporating the locked printer user name's password, for example as specified in FIG. 3A(2). The code line “@PJL SET LIFETIME=‘1 DAY’//” is a PCL command line incorporating an automatic job delete time set for example by a user or network administrator. The code line “@PJL SET HOP=‘4’//” is a PCL command line which specifies the number of routers the locked print job can be passed through. The value of “4” is characteristic of a typical number. Other hop value restrictions common to the invention include but are not limited to values up to 25 or 50. The hop value may be related to the number of routers at a local users site where the print job is being distributed to. For example, as explained in detail later, the locked print job may be distributed over multiple subnets providing a user greater flexibility in the print resources available to him or her in printing the job. The code line “@PJL SET CLEARATPRINT=‘ON’//” is a PCL command line which clears the locked print job from all printers that received the broadcast locked print job.

These PCL command lines above provide a mechanism in the invention by which job handling instructions are communicated to the remote network devices 14.

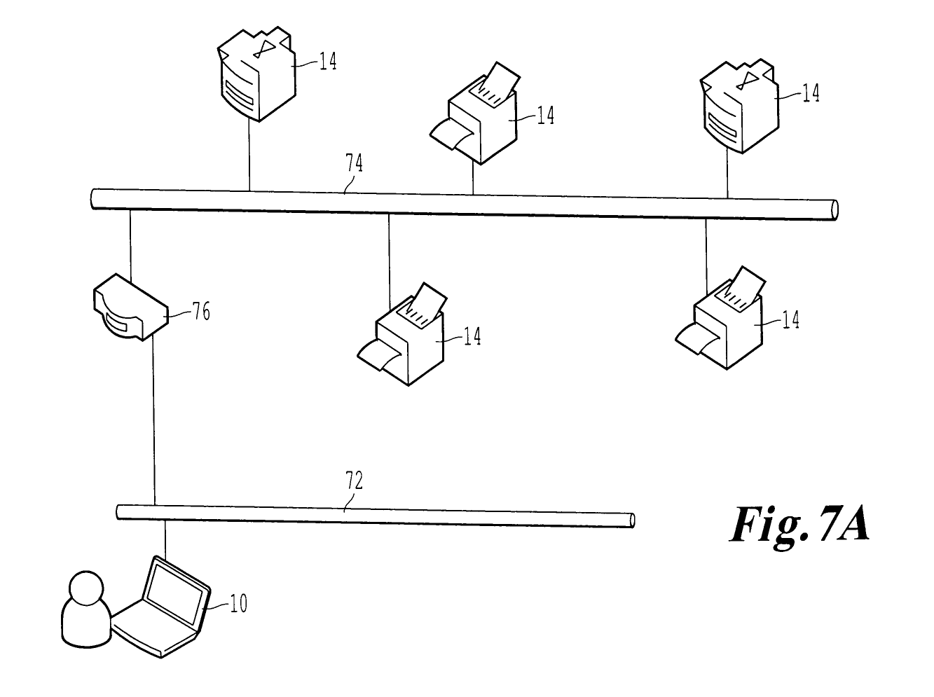

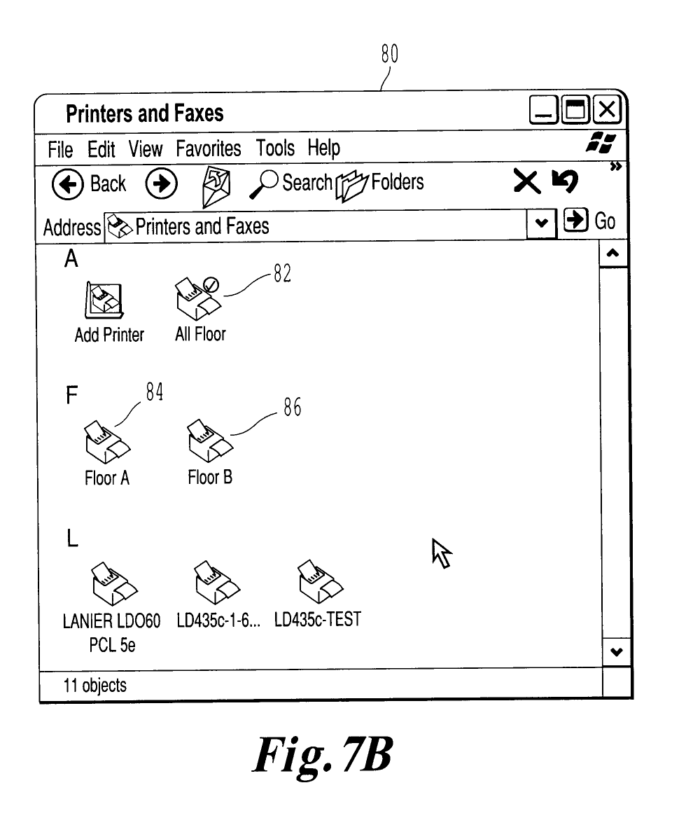

To illustrate further the capability of the invention to communicate over different subnets, FIG. 7A is a network schematic showing a network device 12 which is in communication to remote devices 14 on subnet 72 and on subnet 74. In this embodiment, the broadcast sends the locked print job to the remote devices 14 on subnet 72 and subnet 74. In one embodiment, the remote devices 14 themselves serve as the interface between subnet 72 and subnet 74. In another embodiment, the interface between subnet 72 and subnet 74 is provided by a multifunction printing device 76 which includes the capability to forward the locked print jobs beyond the originating network (i.e., in the example of FIG. 7A to subnet 74). Multifunction printing devices besides having the capability to forward the locked print jobs can also have the capability to fax, scan, and copy documents.

In this configuration, a printer queue can be created for each printer (or network device) on the subnet 72, each printer on subnet 74, or for all printers. For example, if Floor A's network is subnet A and Floor B's network is subnet B, then one may create only two printer queues for Floor A and Floor B instead of all printer queues. In another embodiment of the invention, all printers within a subnet can be represented by one printer queue. In another embodiment of the invention, all printers within all subnets can be represented by one printer queue. For example, with an “all-floor” queue, broadcast will be sent to the network, and the job will be forwarded to the other subnet.

FIG. 7B is an exemplary window screen 80 which can be utilized by a user to show a queue of locked print jobs. In this embodiment, the user can either find all print jobs by clicking on the “All Floor” icon 82, or can find print jobs residing in subnets of the network such as “Floor A” icon 84 or “Floor B” icon 86. Additionally, the user can find the print jobs residing in particular printers by clicking on the listing icons of individual printers shown at the bottom of the window screen.

The locked print process of the invention in one embodiment may perform various “housekeeping” and logging functions. For example, the locked print process may automatically delete print data from storage in memory of the remote devices 14. A wide variety of criteria may be used to perform automatic deletion of print data and the invention is not limited to any particular criteria. For example, the locked print process may detect that memory of one of the remote devices 14 is nearly full and then automatically deletes print data stored thereon. The detection may be made, for example, when the amount of available storage falls below a specified threshold. Once a determination has been made that print data should be deleted, then the locked print process causes print data to be deleted until a sufficient amount of storage has been made available. This may be accomplished, for example, by deleting the oldest print data from memory of one of the remote devices 14. Various other heuristics may be used to select particular print data to be deleted. As an alternative to automatically deleting print data based upon less than a threshold amount of memory being available, the locked print process can automatically delete print data based upon expiration, i.e., print data that is older than a specified time. Indeed, expiration dates may be specified for any of the locked print jobs broadcast over the network 12, such as illustrated above with the “@PJL SET LIFETIME=‘1 DAY’//” PCL command line.

According to another embodiment of the invention, the locked print process can generate and maintain log data that records locked printing events that occur on a network device 14. The particular data included in the log data may vary, depending upon a particular implementation, and the invention is not limited to any particular log data. Examples of log data include, without limitation, print data received by network device 14 and how that print data was processed, e.g., printed, forwarded to another network device for remote printing, or deleted. Different levels of logging may be provided, based upon the amount of details desired. According to one embodiment of the invention, names of print data or print jobs may be excluded from log data. This may be useful in situations where print data contains sensitive information.

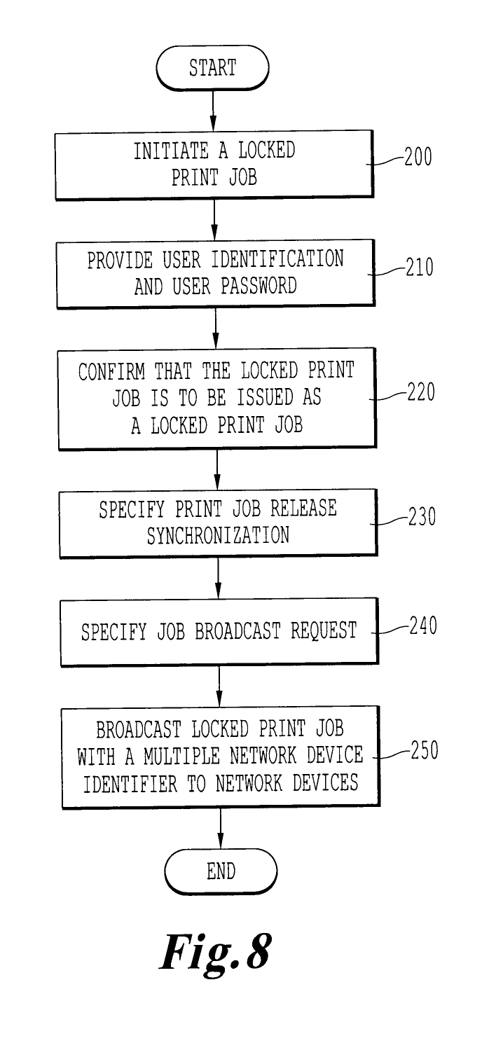

FIG. 8 is a flowchart detailing a method of the invention for issuing and controlling locked print jobs between different networks. At 200 in FIG. 8, a locked print job is initiated by a user. At 210, a user identification and password is provided for the to-be-issued locked print job. At 220, the user confirms that the job to-be-printed is to be a locked print job. At 230, the user specifies print job release synchronization, which if specified as “YES” indicates that when the print job is released and printed at one of the remote devices 14, it will be deleted at the other remote devices 14. If specified as “NO,” then this will indicate the locked print job will remain at the other remote devices for also printing until the print job expires. At 240, the job broadcast request is specified. If specified as “YES,” this indicates that the print job is to be broadcast to multiple subnets such as subnet 702 and subnet 704. If specified as “NO,” this indicates that the print job is to be broadcast only over the subnet connected directly to the network device 102 (in this example subnet 702). At 250, the locked print job is broadcast with a multiple network device identification to network devices, such as for example to the remote devices 14 on subnet 72 or subnet 74, or to the remote devices 14 on network 12, or to another available network 9 (as specified by the job broadcast request).

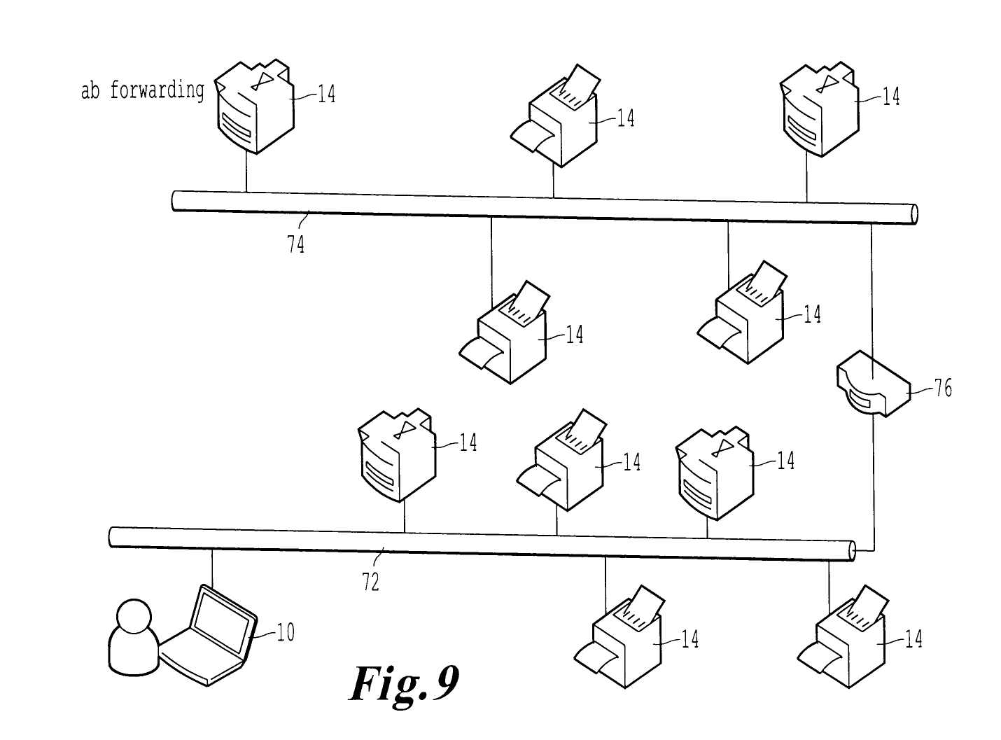

To illustrate yet another the capability of the invention to communicate over different subnets, FIG. 9 is a network schematic showing a network device 10 which is in communication to remote devices 14 on subnet 72 and subnet 74. In this configuration, the network device 10 broadcasts the locked print job to all remote devices 14. In this embodiment, the broadcast sends the locked print job to the remote devices 14 on subnet 72 and subnet 74. Here, the remote devices 104 themselves serve as the interface between subnet 72 and subnet 74. In another embodiment of the invention, the interface between subnet 72 and subnet 74 is provided by a multifunction printing device 76 which includes the capability to forward jobs beyond the originating network.

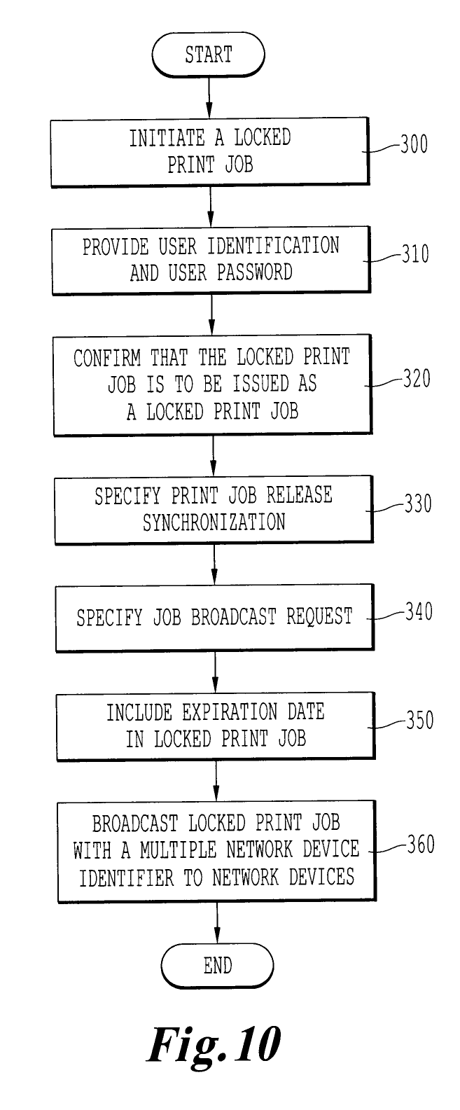

FIG. 10 is a flowchart detailing another method of the invention for issuing and controlling locked print jobs between different networks. At 300 in FIG. 10, a locked print job is initiated by a user. At 310, a user identification and password is provided for the to-be-issued locked print job. At 320, the user confirms that the job to-be-printed is to be a locked print job. At 330, the user specifies job release synchronization, which if specified as “YES” indicates that when the print job is released and printed at one of the remote devices 104, it will be deleted at the other remote devices 104. If specified as “NO,” then this will indicate the locked print job will remain at the other remote devices for also printing until the print job expires. At 340, job forwarding is specified. If specified as “YES,” this indicates that the print job is to be broadcast to multiple subnets such as subnet 902 and subnet 904. If specified as “NO,” this indicates that the print job is to be broadcast only over the subnet connected directly to the network device 102 (in this example subnet 902). At 350, the expiration date of the locked print job is included in print job language commands. At 360, the locked print job is broadcast with a multiple network device identification to the remote devices 14 on subnet 72 or subnet 74, or to remote devices 14 on network 12, or to another available network 9 (as specified by the job broadcast request)

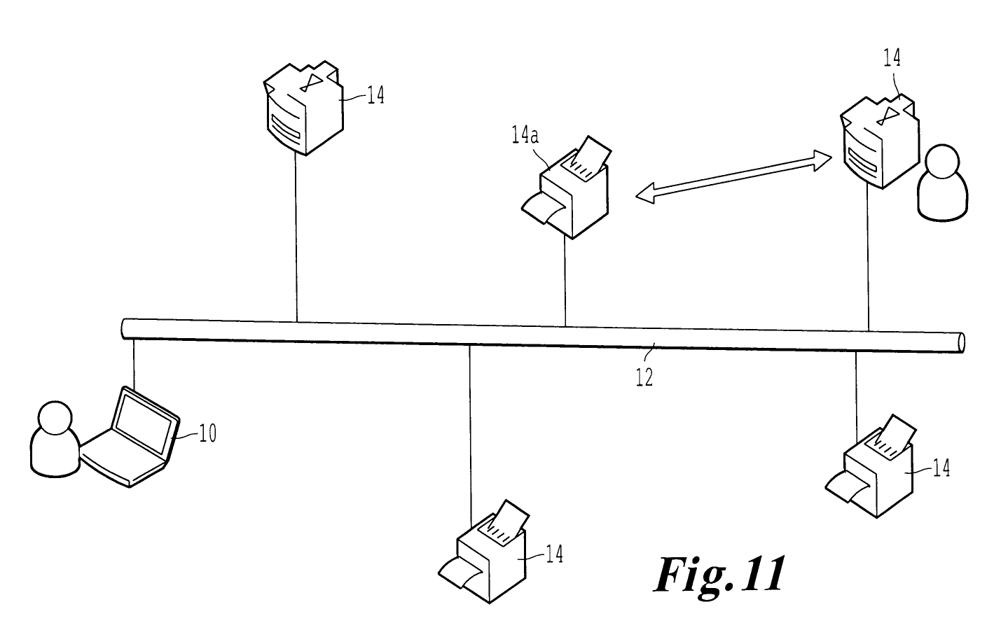

To illustrate yet another the capability of the invention to control print jobs, FIG. 11 is a network schematic showing a network device 10 which is in communication to remote devices 14 on network 12. In this embodiment, locked print job information can be broadcast simultaneously or nearly simultaneously to all available printers on a network or sub-network. The locked print job information contains information as to where the locked print job resides on the network or sub-network.

For example, a locked print job (including the print job data) can be sent to a preferred destination printer 14a by unicast. The destination printer 14a can receive the job and can broadcast job information (and in one embodiment without the print job data) to remote printers 14 on the network 12. In this example, an enhanced Locked Print (ELP) application on preferred destination printer 14a can broadcast job information (after receiving original job data from network device 10) to other remote devices 14. An ELP application on one of the remote devices 14 can receive the job information from preferred destination printer 14a via the broadcast and can thereafter send a request to the preferred destination printer device 14a upon user job release request. When ELP on preferred destination printer 14a receives the request, then the job data is sent to the requester (i.e., the remote device 14 which sent the request).

The job information can include any of the items discussed above such as for example 1) job name, 2) destination printer IP address, 3) job expiration date, 4) locked print user name, etc. The remote printers 14 will then be aware of where the locked print job resides. When user walks up to one of the remote devices 14 (such as the one depicted on the far right-hand side of FIG. 11), the user can for example login and view all locked print jobs which user sent to any of the devices 14 or 14a.

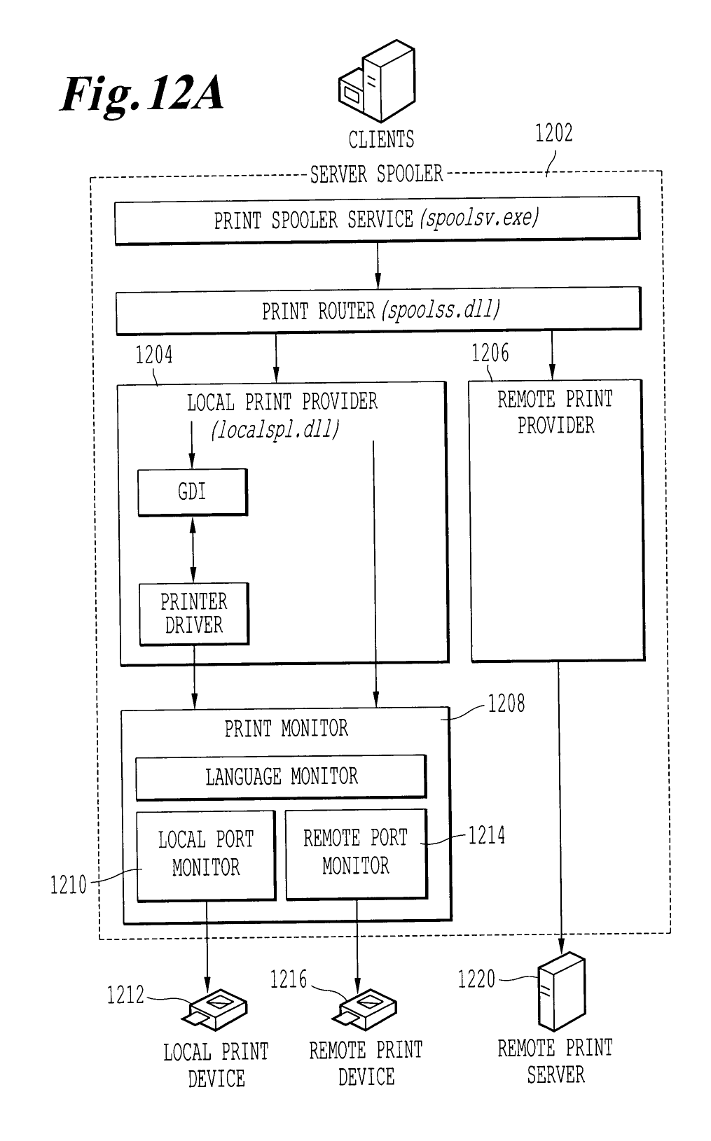

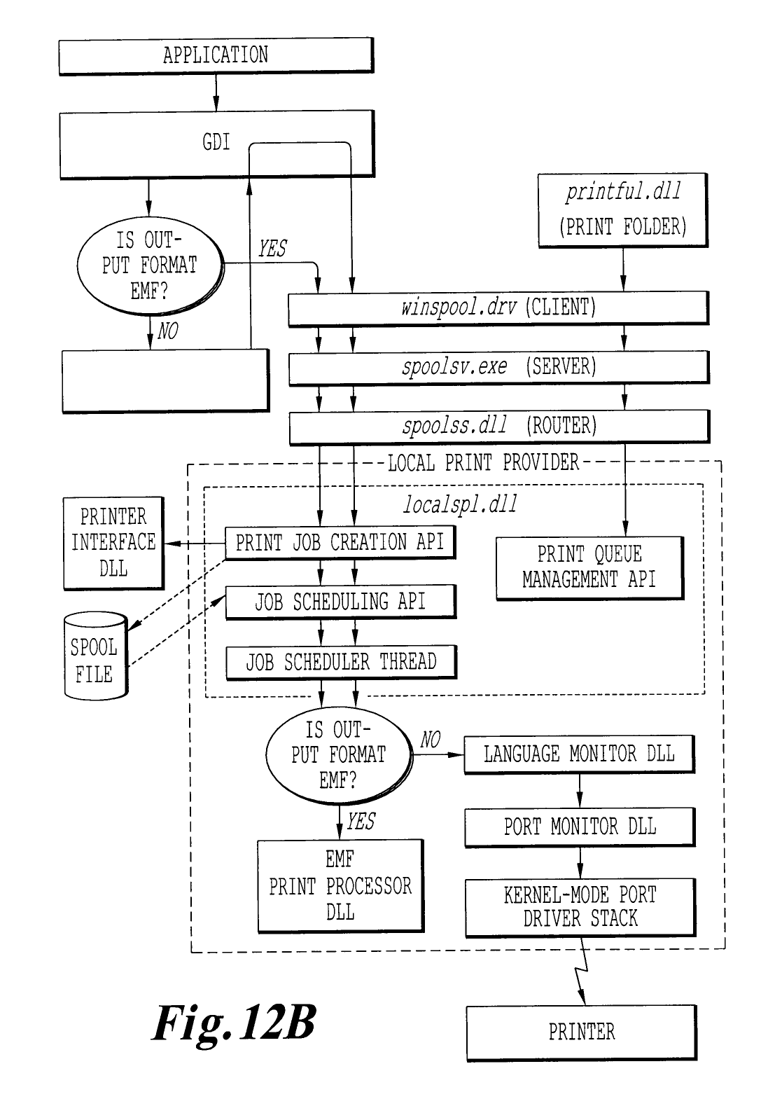

The above-noted procedures can be implemented on a variety of network devices with or without a print server. FIG. 12A is a windows configuration in which no network print server is required. In this configuration, a client server spooler 1202 (such as for example at network device 100 in FIG. 2) processes the loaded print job request. The server spooler 1202 includes a local print provider 1204 and a remote print provider 1206. The local print provider 1204 after compiling the print job (including graphics and text) outputs the locked print job to print monitor 1208. The print monitor 1208 translates the graphics and text into PJL format (such as described above) and outputs the locked print job either through a local port monitor 1210 to a local port device 1212 (i.e., a local printer) or through a remote print monitor 1214 to remote print devices 1216. The remote port monitor 1214 can add PJL commands to the print object before the locked print job is sent with UDP based on port configuration. The remote print devices 1216 can be any of the remote devices 104 described above.

As shown in FIG. 12A, print jobs in client server spooler 1202 can be routed to other remote servers 1218 by way of remote print provider 1206.

FIG. 12B is a high level flow diagram depicting this process. As FIG. 12B shows, an application creates a print job by calling the Graphics Driver Interface (GDI). Regardless of whether the print job's initial output format is enhanced metafile (EMF), the local print provider's job creation application program interface (API) creates a spool file. Later, when the job is scheduled, the spool file is read and, if the format is enhanced metafile, the EMF print processor sends the job back to GDI for conversion to RAW format, with the help of a printer graphics dynamic link library (DLL). The converted data stream can then be sent back through the local print provider to the printer (without being respooled).

Accordingly, in one embodiment of the invention, an application from which a print job is derived submits a locked print job to be printed. The to be printed locked print job passes to a graphical display interface (GDI). GDI is a windows interface for representing graphical objects and transmitting the graphical objects to output devices such as monitors and printers. If the output format does not contain enhanced metafile objects (EMF), then the to be printed locked print job passes to printer graphics DLL module. Printer graphics DLLs typically produce an output stream in a raw data type (including command sequences) that the spooler can send to printer hardware through print monitors. If the output format does contain enhanced metafile objects (EMF), then the to be printed locked print job passes to a number of spooler devices (e.g., winspool, spoolsv, and spoolss) which direct and store print information to be sent to a printer.

From there, the to be printed locked print job proceeds to a local print provider. Print providers are typically responsible for directing print jobs to local or remote print devices and are responsible for print queue management operations, such as starting, stopping, and enumerating print queues. Print providers typically implement a common set of print provider capabilities defined by a set of functions from spool files, accessible by the print providers. Indeed, as shown in FIG. 12B, the local print provider contains print job creation, print job queue, and job scheduling functions.

Once output from the local print provider, the to be printed locked print job proceeds to the language monitor, port monitor, and kernel-mode port driver stack modules which incorporate the print job information necessary for broadcast of the to be printed locked print job to the remote network devices. If the output from the local print provider is not in an EMF format, then the output is rerouted to an EMF print processor, and then is routed back to the graphical display interface (GDI) and reprocessed.

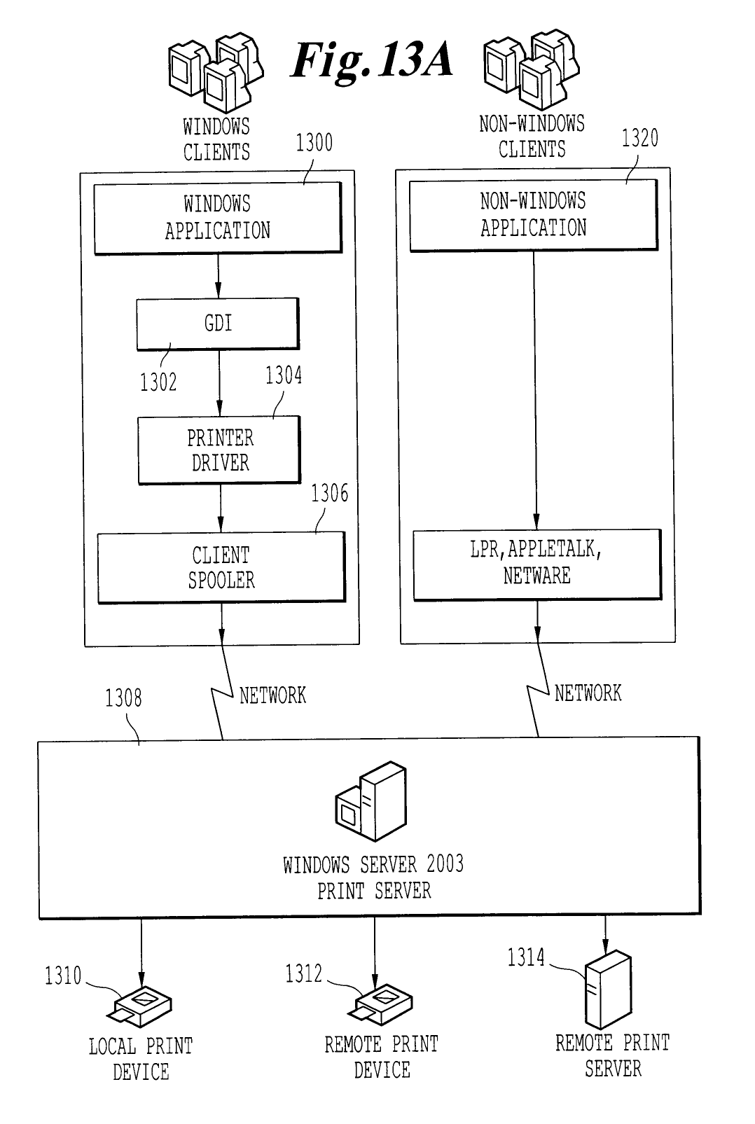

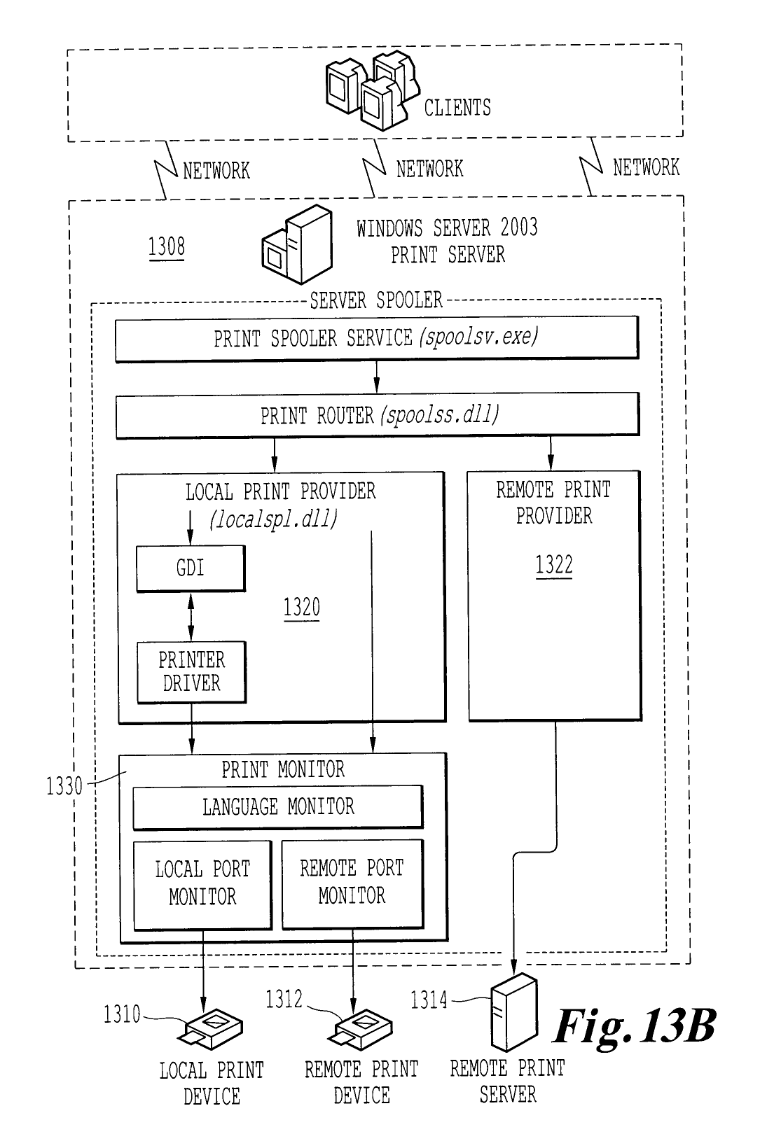

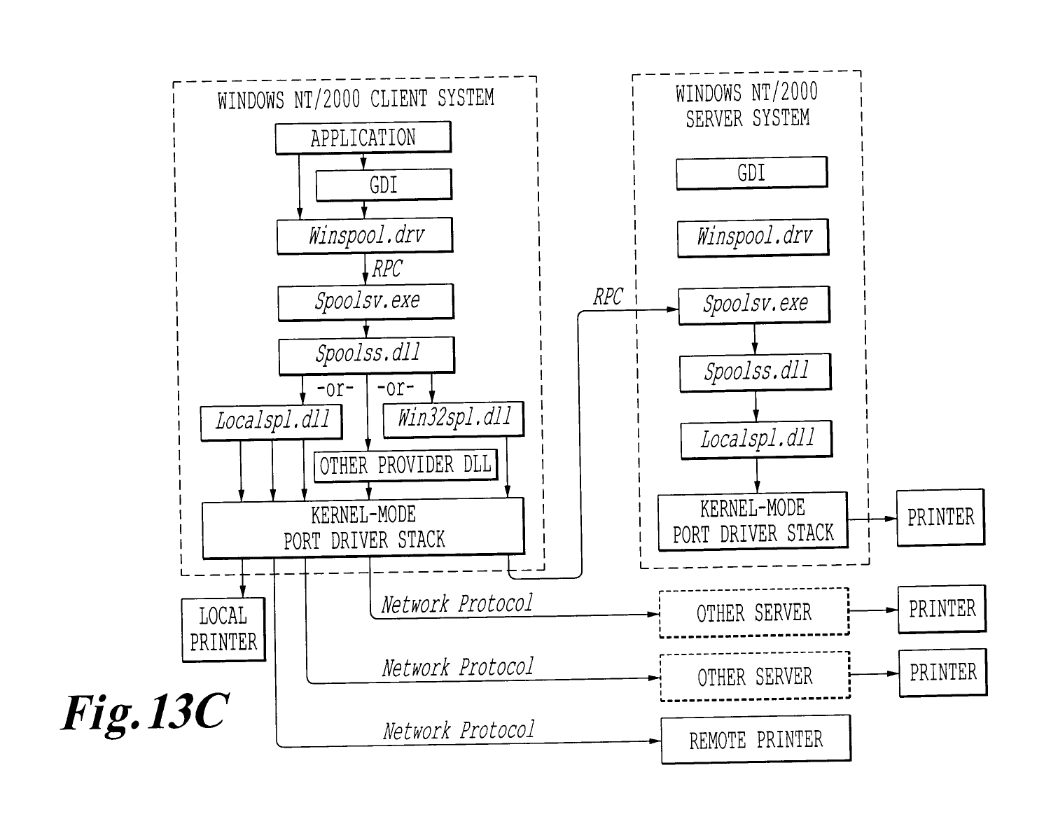

FIG. 13A is a windows configuration in which a network print server is utilized. In this configuration, windows and non-windows users submit printing jobs to be printed. The print job is initiated from windows application 1300, which issues the print jobs through GDI 1302 to printer driver 1304 and client spooler 1306 to a network including a network print server 1308. The network print server 1308 can (if needed) take the text and graphics data and transform this data into PJL format including the adding of specific codes as discussed above in order to control the to-be-issued locked print job. The network print server 1308 submits the locked print job to either a local printer 1310, a remote print device 1312, or a remote print server 1314. Non-windows user devices 1320 submits jobs when the network print server 1308 transforms (converts) into appropriate PJL commands for distribution to either the locked print device 1310, the remote print device 1312, or the remote print server 1314.

FIG. 13B is a schematic showing specifically the handling of locked print jobs by network print server 1308. In particular, FIG. 13A shows the inclusion in network print server 1308 of a print monitor 1330, which performs the same function as the above-noted print monitor 1214. The local print provider 1320 performs similar functions as local print provider 1204. The remote print provider 1322 performs similar functions as remote print provider 1206.

FIG. 13C is a high level flow diagram depicting this process. In the depicted process, an application from which a print job is derived submits a locked print job to be printed from a local client or user device. The to be printed locked print job passes to a graphical display interface (GDI). Then, the to be printed locked print job passes through a number of spooler devices (e.g., winspool, spoolsv, and spoolss) before being presented to a kernel-mode port driver stack module. From the kernel-mode port driver stack module, the to be printed locked print job can be distributed to a server system to remote printers, or to other servers distributing the locked print job.

Accordingly, different embodiments of the invention can utilize a method, a system, or a computer program product for controlling printing across a plurality of network devices. While discussed below with regard to a method, the functions and processes are implemental in the systems described above and the computer program products described below.

In general, the method for controlling printing across a plurality of network devices generates a locked print job to be distributed to the plurality of network devices, assigns a user identification for identification of the locked print job at the network devices, and assigns a user password for print job authorization of the locked print job at the network device. The method broadcasts with a multiple network device identification print job information regarding the locked print job to the plurality of network devices.

The broadcasting in one embodiment broadcasts the locked print job without user identification of a specific network device for printing of the locked print job. The broadcasting in one embodiment broadcasts the print job information including print job instructions to all of the network devices. The broadcasting in one embodiment broadcasts only the user identification and password to all network devices and broadcasts print job instructions to a designated network device.

The locked print job can be printed from one of the network devices by accessing and releasing the locked print job at one of the network devices (for example at one of the network devices where the user who issued the locked print job is presently located). Authorization of the printing of the locked print job can be had by confirming the user identification and the user password before printing the locked print job. When the locked print job was only broadcast to a designated network device, printing the locked print job from any one of the network devices can be permitted by accessing the locked print job at the designated network device, and then authorizing the printing of the locked print job by confirming the user identification and the user password before printing the locked print job. Regardless of how the locked print job is distributed to the network devices, in one embodiment of the invention, after the locked print job is printed at one of the network devices, the locked print job is released from all of the network devices.

In one embodiment, the simultaneous broadcast of the print job information occurs by 1) specifying a printer port by which all the network devices receive the print job information and 2) transmitting the locked print job to the specified printer port. As detailed more specifically above, an Internet Protocol data packet can be formed for transmitting the locked print job to the network devices, in which the data packet can specify a universal IP address or alternatively can be automatically given the IP addresses of all the network devices available for receiving the locked print job. The Internet Protocol data packet can include a datagram (using for example the above noted universal datagram protocol) including pint job instructions and the specified printer port.

The datagram can include the print job instructions print job data, the user identification, and the password. The datagram can include at least one a job expiration date, a job broadcast request, a job release synchronization, and a length of the print job data. As explained in more detail above, the job expiration specifies a date when the locked print job is to be deleted from the network devices, regardless of whether or not the locked print job has been printed. The job broadcast request specifies a number of networks to which the locked print job is distributed. The job release synchronization specifies whether the locked print job is deleted or not from one of the network devices upon printing at another of the network printing devices.

In one embodiment, a printer queue for the network devices is generated. The locked print job from one of the network devices can be printed by accessing the printer queue to release the locked print job. Further, authorization of the printing of the locked print job can be performed by confirming the user identification and the user password before printing the locked print job.

In one embodiment, the locked print job can be broadcast to a plurality of networks connecting to the network devices. The locked print job can be transferred between the plurality of networks by transfer through a print server or by transfer through a multifunction printer.

Accordingly, the servers and other network devices discussed above can be used to implement the methods disclosed herein by way of included computing devices such as for example a motherboard, a central processing units (CPU), memory (e.g., DRAM, ROM, EPROM, EEPROM, SRAM, SDRAM, and Flash RAM), and other optical special purpose logic devices (e.g., ASICS) or configurable logic devices (e.g., GAL and reprogrammable FPGA). The network devices can also include plural input devices, (e.g., keyboard and mouse), and can include a display card controlling a monitor showing the user the status of and options for the locked print job. The network devices have various known printing capabilities (laser jet, ink jet, etc,) by which the locked print job can be printed or otherwise reproduced. The network devices (through the display card or other suitable mechanism may also have the capability to display the locked print job at any one of remote devices, thereby permitting a user to review the locked print job before printing.

The networks described above to interconnect the network devices can be wired or wireless communication networks. Commands executing the methods of the invention may then be broadcast over the network(s) or a part of the network(s) as electrical or optical signals. Encryption of the signals can be used to further enhance security of the locked print jobs.

Additionally, the network devices may include a floppy disk drive; other removable media devices (e.g. compact disc, tape, and removable magneto-optical media); and a hard disk or other fixed high density media drives, connected via an appropriate device bus (e.g., a SCSI bus, an Enhanced IDE bus, or an Ultra DMA bus). The network devices may also include a compact disc reader, a compact disc reader/writer unit or a compact disc device, which may be connected to the same device bus or to another device bus.

The network devices can includes at least one computer readable medium. Examples of computer readable media are compact discs, hard disks, floppy disks, tape, magneto-optical disks, PROMs (e.g., EPROM, EEPROM, Flash EPROM), DRAM, SRAM, SDRAM, etc. Stored on any one or on a combination of computer readable media, the invention includes software for controlling both the hardware of the network devices and for enabling the network devices to interact with a human user and each other. Such software may include, but is not limited to, device drivers, operating systems and user applications, such as development tools.

Such computer readable media further includes computer program products for performing the inventive method herein disclosed. The computer code devices of the invention can be any interpreted or executable code mechanism, including but not limited to, scripts, interpreters, dynamic link libraries, Java classes, and complete executable programs.

The invention may also be implemented by the preparation of application specific integrated circuits or by interconnecting an appropriate network of conventional component circuits, as will be readily apparent to those skilled in the art.

Numerous modifications and variations on the present invention are possible in light of the above teachings. It is, therefore, to be understood that within the scope of the accompanying claims, the invention may be practiced otherwise than as specifically described herein.

1. A method for controlling printing across a plurality of network devices, comprising:
generating a locked print job to be distributed to the plurality of network devices;
assigning a user identification for identification of the locked print job at the network devices;
assigning a user password for print job authorization of the locked print job at the network devices; and
broadcasting with a multiple network device identification print job information regarding the locked print job to the plurality of network devices.

2. The method of claim 1, wherein broadcasting comprises broadcasting the locked print job without user identification of a specific network device for printing of the locked print job.

3. The method of claim 1, wherein broadcasting comprises broadcasting print job instructions to all of the network devices.

4. The method of claim 3, further comprising:
authorizing printing of the locked print job by confirming the user identification and the user password before printing the locked print job; and
printing the locked print job by accessing and releasing the locked print job at one of the network devices.

5. The method of claim 1, further comprising:
releasing the locked print job from the network devices after the locked print job is printed at one of the network devices.

6. The method of claim 1, wherein broadcasting comprises:
broadcasting only the user identification and password to all network devices; and
broadcasting print job instructions to a designated network device.

7. The method of claim 6, further comprising:
printing the locked print job by accessing the locked print job at the designated network device.

8. The method of claim 7, further comprising:
authorizing printing of the locked print job by confirming the user identification and the user password before printing the locked print job; and
printing the locked print job by accessing and releasing the locked print job at one of the network devices.

9. The method of claim 1, wherein broadcasting comprises:
specifying at least one printer port by which the network devices receive the print job information; and
transmitting the locked print job to the at least one specified printer port.

10. The method of claim 9, wherein transmitting comprises:
forming an Internet Protocol data packet for transmitting the locked print job to the network devices, the data packet specifying at least one of a universal IP address or a listing of IP addresses of the network devices.

11. The method of claim 10, wherein forming comprises:
including in the Internet Protocol data packet a datagram including pint job instructions and the at least one specified printer port.

12. The method of claim 11, wherein forming further comprises:
including in the print job instructions print job data, the user identification, and the password.

13. The method of claim 12, further comprising:
including in the print job instructions at least one of a job expiration date, a job broadcast request, a job release synchronization, and a length of the print job data,
said job expiration specifying a date when the locked print job is to be deleted from the network devices,
said job broadcast request specifying a number of networks to which the locked print job is distributed, and
said job release synchronization specifying whether the locked print job is deleted or not from one of the network devices upon printing at another of the network printing devices.

14. The method of claim 1, further comprising:
generating a printer queue for the network devices; and
printing the locked print job from one of the network devices by accessing the printer queue to release the locked print job.

15. The method of claim 14, further comprising:
authorizing printing of the locked print job by confirming the user identification and the user password of the locked print job before printing the locked print job.

16. The method of claim 1, wherein broadcasting comprises broadcasting the locked print job to a plurality of networks connecting to the network devices.

17. The method of claim 16, further comprising:
transferring the locked print job between the plurality of networks by transfer through a print server.

18. The method of claim 16, further comprising:
transferring the locked print job between the plurality of networks by transfer through a multifunction printer.

19. A system for controlling printing across a plurality of network devices, comprising:
a network connecting to the plurality of network devices;
an originating network device of the plurality of network devices, which generates a locked print job to be distributed to the plurality of network devices; and
said originating network device configured to,
assign a user identification for identification of the locked print job at the network devices;
assign a user password for print job authorization of the locked print job at the network devices; and
broadcast with a multiple network device identification print job information regarding the locked print job to the plurality of network devices.

20. A computer program product embedded in a computer readable medium which when executed causes a processor to execute the following functions for controlling printing across a plurality of network devices, comprising:
generating a locked print job to be distributed to the plurality of network devices;
assigning a user identification for identification of the locked print job at the network devices;
assigning a user password for print job authorization of the locked print job at the network devices; and
broadcasting with a multiple network device identification print job information regarding the locked print job to the plurality of the network devices.
